(19) United States
(12) Patent Application Publication
(10) Pub. No.: US 2005/0220444 A1
(43) Pub. Date: Oct. 6, 2005

(54) Content recording method, content recording system, and recording and playing device

(75) Inventors: Hideki Ohkita, Tokyo (JP); Takashi Kokubo, Tokyo (JP); Jun Okazaki, Kanagawa (JP); Hiroyuki Chaki, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/094,792

(22) Filed: Mar. 31, 2005

(30) Foreign Application Priority Data
Mar. 31, 2004 (JP) 2004/108115

(51) Int. Cl. H04N 5/781

(52) U.S. Cl. 386/125

(57) ABSTRACT

A device on the sending and playing device plays and outputs a content recorded to a recording medium on the sending side. A device on the receiving and recording side receives the played and outputted content and records it to a recording medium on the receiving side. The device on the sending and playing device erases the content recorded to the device on the sending and playing device based on recording-state information of the device on the receiving and recording side by using the sent played content. Thus, in move processing of a “Copy Once” content, it is possible to prevent the loss of content by the device on the sending and playing side when the device on the receiving and recording and side does not normally record the content.

### CROSS-REFERENCE TO RELATED APPLICATIONS

This application is based upon and claims the benefit of priority from the prior Japanese Patent Application No. 2004-108115 filed on Mar. 31, 2004; the entire contents of which are incorporated herein by reference.

### BACKGROUND OF THE INVENTION

1. Field of the Invention

The present invention relates to a content recording method, a content recording system, and a recording and playing device which are used for recording and using a content distributed from a broadcasting station side.

2. Description of the Related Art

Recently, copyright protecting information is added to a content to secure the copyright of content of a program comprising a video image and audio data and a program comprising data distributed from a broadcasting station, and data of data broadcasting. The copyright protecting information limits recording processing of contents, processing for moving the contents recorded to one predetermined recording medium to another recording medium, and the like.

For example, copyright protecting information indicating a “Copy Once content” is added to the contents for permitting recording an image only once. The “Copy Once” content permits one-time recording, and does not permit the copying operation to another recording medium. The “Copy Once” content permits the recording to a recording medium of another recording device under a condition for deleting the recorded “Copy Once” content after recording it to the recording medium of another recording device.

That is, in the case of processing (hereinafter, referred to as “move processing”) for moving the content to one recording medium to another recording medium, in a recording and playing device using a rule predetermined to a copyright protecting function, after a predetermined time for transmitting the recorded content to another recording medium, the content is erased from the recording medium serving as the transmitting source, thereby permitting the transmission and recording to the other recording device.

For example, a recording and playing device on the sending side in the move processing is a recording and playing device, with a hard disk (HDD) serving as a recording medium, which records the “Copy Once” content distributed from the broadcasting station side, and a recording and playing device on the receiving side is a recording and playing device, with a DVD-RAM serving as a recording medium. As mentioned above, in the move processing, the “Copy Once” content recorded to the recording and playing device on the sending side is sent and is recorded to the recording and playing device on the receiving side, and the sent “Copy Once” content is erased from the hard disk by the recording and playing device on the sending side.

In this case, the power of the recording and playing device on the receiving side might be turned-off during the move processing. The recording and playing device on the sending side continuously sends the data, and the sent “Copy Once” content is erased after a predetermined time. Since the power of the recording and playing device on the receiving side is turned off, the “Copy Once” content sent from the recording and playing device on the sending side is not recorded to the recording and playing device on the receiving side.

Japanese Unexamined Patent Application Publication No. 2002-300517 (hereinafter, referred to as Patent Document 1) discloses a technology for, in the case of turning-off the power of any of the recording and playing devices on the receiving and sending sides, detecting the “turning off”, adding EOB (End of bit) to the end of a playing stream from the recording and playing device on the sending side, outputting it to the recording or playing device on the receiving side, and turning-off the power of the recording and playing device on the receiving side after checking the recording the data until detecting EOB.

That is, according to Patent Document 1, in the case of turning-off the power during the move processing, EOB is added to the sending content. The stream to EOB is recorded to the recording and playing device on the receiving side and, on the other hand, it is possible to prevent the erasure of the content by recording and holding the stream sequent to EOB (non-sent content) to the recording and playing device on the sending side.

According to Patent Document 1, the unnecessary erasure of content upon turning-off the power is prevented. However, when the recording and playing device on the receiving side does not normally record the content sent from the recording and playing device on the sending side, the content sent by the recording and playing device on the sending side is erased after a predetermined time. In this case, the erasure of sent content disables the recording of content to either of the recording and playing devices on the receiving and sending sides.

### BRIEF SUMMARY OF THE INVENTION

It is an object of the present invention to provide a content recording system to prevent the undesired erasure of a content of copyright protecting information under the control of sending and erasing operations of the content recorded to a recording and playing device on the sending device in accordance with receiving and recording states of the content of the recording and playing device on the receiving side.

According to the present invention, a content recording method comprises: step to record a received content to a first recording medium; step to play the content recorded to the first recording medium; step to record the content played from the first recording medium to a second recording medium; step to produce recording-state information indicating a recording state to the second recording medium; and step to erase the content recorded to the first recording medium based on the recording-state information.

The above and other objects, features and advantages of the invention will become more clearly understood from the following description referring to the accompanying drawings.

### BRIEF DESCRIPTION OF THE DRAWINGS

FIG. 1 is a block diagram showing the structure of a device on the sending and playing side used for a content recording system according to a first embodiment of the present invention;

FIG. 2 is a block diagram showing the structure of a device on the receiving and recording side used for the content recording system according to the first embodiment of the present invention;

FIG. 3 is a block diagram explaining a move processing operation between the device on the sending and playing device and the device on the receiving and recording side using a video signal of the content from the content recording system according to the first embodiment;

FIG. 4 is a block diagram explaining a move processing operation between a device on the sending and playing side and a device on the receiving and recording side using an identification (ID) information signal of a content in a content recording system according to a second embodiment of the present invention;

FIG. 5 is a block diagram explaining a move processing operation between a device on the sending and playing side and a device on the receiving and recording side using a recording signal of a content in a content recording system according to a third embodiment of the present invention;

FIG. 6 is an explanatory diagram showing a sending format and the recording of the ID information between the device on the sending and playing side and the device on the receiving and recording side in the content recording system according to an embodiment of the present invention;

FIG. 7 is an explanatory diagram showing a format of an ID information requesting command to the device on the receiving and recording side from the device on the sending and playing side in the content recording system according to an embodiment of the present invention;

FIG. 8 is an explanatory diagram showing a format of the ID information returning command to the device on the sending and playing side from the device on the receiving and recording side in the content recording system according to an embodiment of the present invention;

FIG. 9 is an explanatory diagram showing a format of a recording-information requesting command to the device on the receiving and recording side from the device on the sending and playing side in the content recording system according to an embodiment of the present invention;

FIG. 10 is an explanatory diagram showing a format of the recording-information returning command to the device on the sending and playing side from the device on the receiving and recording side in the content recording system according to an embodiment of the present invention;

FIG. 11 is a flowchart for the move processing operation between the device on the receiving and recording side and the device on the sending and playing side in the content recording system according to an embodiment of the present invention;

FIG. 12 is an explanatory diagram for the move processing in the content recording system according to an embodiment of the present invention;

FIG. 13 is an explanatory diagram for the recording and erasure of a “Copy Once” content; and

FIG. 14 is an explanatory diagram for copyright protecting information set to the content.

### DETAILED DESCRIPTION OF THE INVENTION

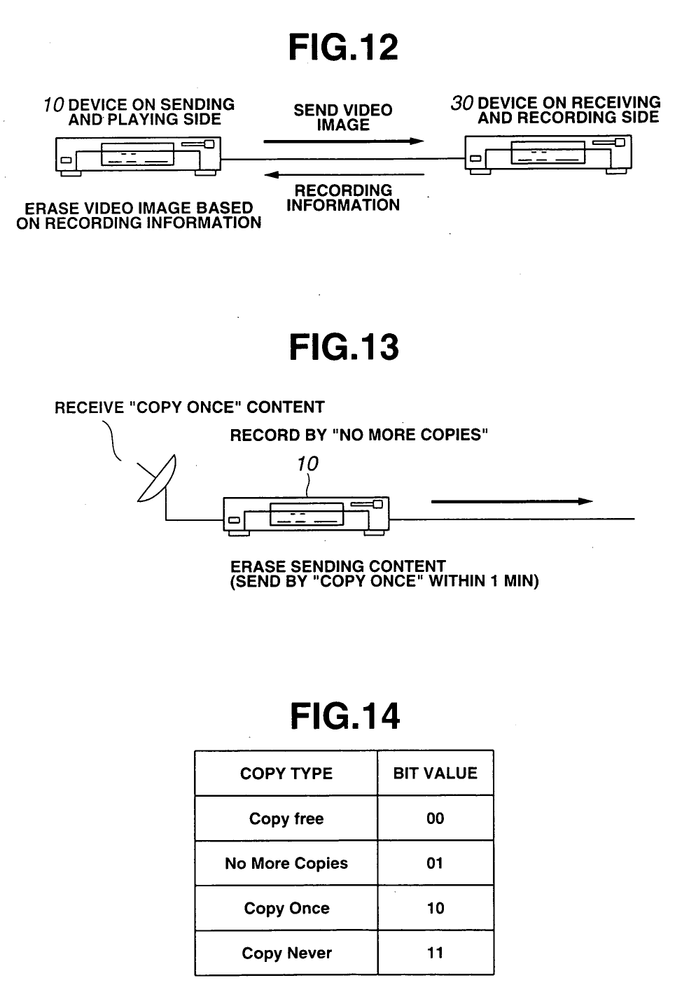

Hereinbelow, a description is given of embodiments of the present invention with reference to the drawings. First, a description is given of the outline of move processing of a “Copy Once” content with reference to FIGS. 12 and 13. FIG. 14 shows copyright protecting information added to the content. The content having a flag “00” indicating the copyright protecting information is a “Copy Free” content, and enables a free copying operation. The content having a flag “10” is the “Copy Once” content for permitting one-time copying operation. In the case of copying the “Copy Once” content to a recording medium, the copyright protecting information thereof is written to a “No More Copies” content indicated by a flag “01”, and the copying operation thereafter is prohibited. The content having a flag “11” is a “Copy Never” content for prohibiting the copying operation.

The “Copy Free” content having the flag “00” indicating the copyright protecting information is freely recorded to the recording medium by the recording and playing device. The “Copy Never” content having the flag “11” prohibits the recording to the recording medium in any recording and playing device. Referring to FIG. 13, the received “Copy Once” content having the flag “10” is rewritten to the “No More Copies” content having the flag “01”, and is copied once by the recording and playing device. In the case of sending the data from the recording and playing device for recording the “Copy Once” content having the flag “01” to another recording and playing device and copying the data to another recording medium, the data is returned from the “No More Copies” content having the flag “01” to the “Copy Once” content having the flag “10” and the move processing for erasing the content recorded to the original recording medium is possible.

Referring to FIG. 12, a content recording system according to the first embodiment comprises: a device 10 on the sending and playing side, serving as a recording and playing device on the sending side, which receives a content, records it, plays the content recorded to the recording medium, and sends it to another recording and playing device; and a device 30 on the receiving and recording side, serving as a recording and playing device on the receiving side, which receives the content played and sent from the device 10 on the sending and playing side and records it to the recording medium.

The device 10 on the sending and playing side performs the move processing of the “Copy Once” content. In the move processing, the device 10 on the sending and playing side receives the “Copy Once” content and records it to the recording medium, and plays the “Copy Once” content recorded to the recording medium and sends it to another recording and playing device. The device 30 on the receiving and recording side receives the played and sent “Copy Once” content and records it to the recording medium.

According to the first embodiment, the device 10 on the sending and playing side controls the erasure of the sent “Copy Once” content based on recording-state information returned from the device 30 on the receiving and recording side.

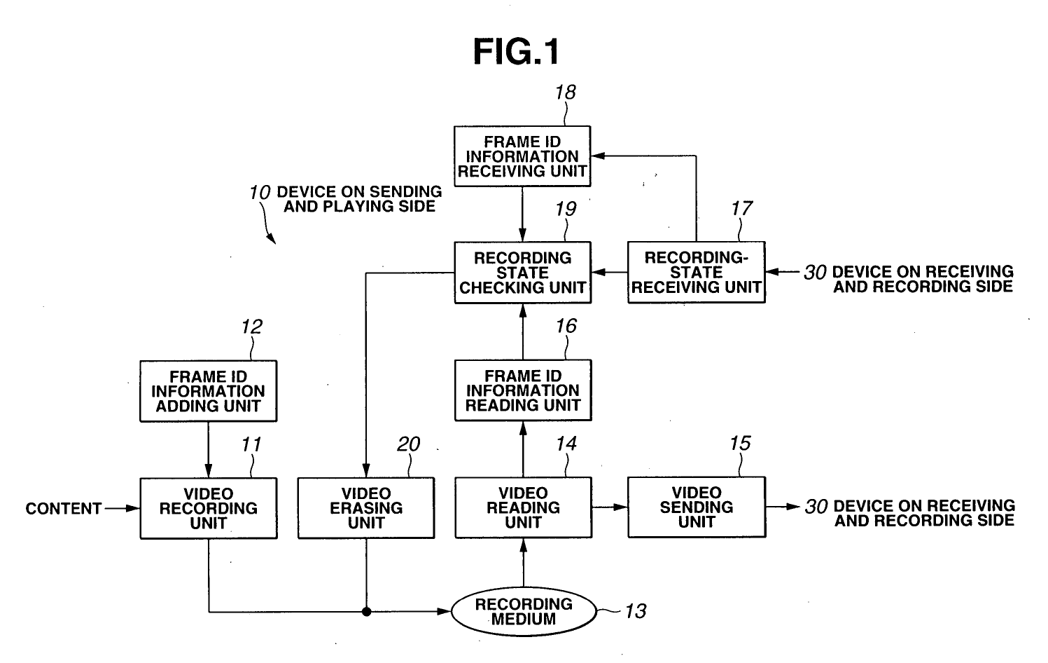

Hereinbelow, a description is given of the structure of the device 10 on the sending and playing side in the content recording system with reference to FIG. 1. The device 10 on the sending and playing side comprises: a video recording unit 11; a frame identification (ID) information adding unit 12; a recording medium 13 on the sending side; a video reading unit 14; a video sending unit 15; a frame ID information reading unit 16; a recording-state receiving unit 17; a frame ID information receiving unit 18; a recording-state checking unit 19; and a video erasing unit 20. The device 10 on the sending and playing side processes the entire contents of “Copy Free”, “Copy Once”, “No More Copies”, and “Copy Never”. However, a description is given of only the “Copy Once” content.

The video recording unit 11 receives the “Copy Once” content having the flag “10” indicating the copyright protecting information distributed from the broadcasting station side, performs predetermined signal processing on the content, converts the processed content into the “No More Copies” content having the flag “01”, and records the converted content to the recording medium 13 on the sending side.

The frame ID information adding unit 12 adds an identification (ID) number (No.) to each video frame of the content in predetermined signal processing of the video recording unit 11. The content having the video frame ID No. added by the frame ID information adding unit 12 is recorded to the recording medium 13 on the sending side. The recording medium 13 on the sending side such as an HDD or a DVD-RAM, writes, records, reads, and plays the data, and erases the recorded data.

The video reading unit 14 plays and reads the “No More Copies” content having the flag “01” recorded to the recording medium 13 on the sending side. The content additionally has the ID No. of each video frame. The video reading unit 14 outputs the read content to the video sending unit 15 and the frame ID information reading unit 16. The video sending unit 15 converts, into the “Copy Once” content having the flag “10”, the “No More Copies” content having the flag “01” including the video frame ID No. from the video reading unit 14, and sends the converted content to the device 30 on the receiving and recording side. The video sending unit 15 is connected to a video receiving unit 31, which will be described later, of the device 30 on the receiving and recording side via using a sending path such as IEEE1394.

The frame ID information reading unit 16 extracts a video frame ID No. from the content read by the video reading unit 14, and temporarily stores the extracted video frame ID No. As will be described later, the device 30 on the receiving and recording side sends recording-state information indicating a recording state of the content of a recording medium 33 on the receiving side. The recording-state receiving unit 17 receives recording-state information from the device 30 on the receiving and recording side. The recording-state receiving unit 17 is connected to the device 30 on the receiving and recording side via a sending path such as IEEE1394.

The frame ID information receiving unit 18 extracts the video frame ID No. from the recording-state information of the content from the device 30 on the receiving and recording side, which is received by the recording-state receiving unit 17.

The recording-state checking unit 19 compares the video frame ID No. that is temporarily stored in the frame ID information reading unit 16 with the video frame ID number extracted by the frame ID information receiving unit 18, and checks whether or not the video frame ID No. of the content sent from the device 10 on the sending and playing side matches the video frame ID No. of the content received and recorded by the device 30 on the receiving and recording side.

The video erasing unit 20 receives, from the recording-state checking unit 19, the matching information between the video frame ID No. of the sending content and the video frame ID No. of the received and recorded by the device 30 on the receiving and recording side. The video erasing unit 20 erases the video frame of the content whose reception and recording in the device 30 on the receiving and recording side are checked among the video frame of the content written and recorded to the recording medium 13 on the sending side based on the matching information of the recording-state checking unit 19.

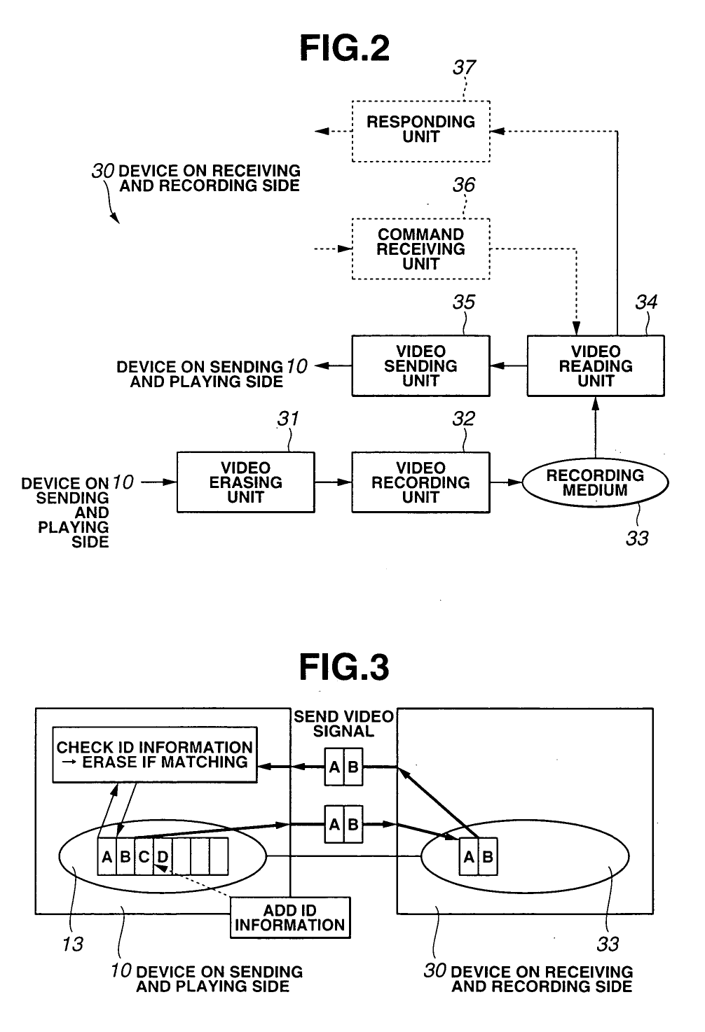

Next, a description is given of the structure of the device 30 on the receiving and recording side with reference to FIG. 2. The device 30 on the receiving and recording side performs the entire contents of “Copy Free”, “Copy Once”, “No More Copies”, and “Copy Never”. Hereinbelow, a description is given of only the “Copy Once” content.

The device 30 on the receiving and recording side comprises: a video receiving unit 31, a video recording unit 32, the recording medium 33 on the receiving side, and a video reading unit 34 which are connected to the video sending unit 15 of the device 10 on the sending and playing side via a sending path such as IEEE1394; and a video sending unit 35 connected to the recording-state receiving unit 17 of the device 10 on the sending and playing side via a sending path such as IEEE1394.

The video receiving unit 31 receives the “Copy Once” content having the flag “10” including the video frame ID No. sent from the video sending unit 15 of the device 10 on the sending and playing side, performs the processing including the noise reduction and amplification, and outputs the processed data to the video recording unit 32.

The video recording unit 32 performs predetermined signal processing on the “Copy Once” content having the flag “10” including the video frame ID No. from the video receiving unit 31, converts the processed data into the “No More Copies” content having the flag “01”, and records the converted data to the recording medium 33 on the receiving side. The recording medium 33 on the receiving side is an HDD, DVD-RAM, digital recording magnetic tape, or the like.

The video reading unit 34 reads the “No More Copies” content having the flag “01” recorded to the recording medium 33 on the receiving side, and outputs the read content to the video sending unit 35.

The video sending unit 35 returns, to the recording-state receiving unit 17 in the device 10 on the sending and playing side, the “No More Copies” content having the flag “01” read by the video reading unit 34 serving as the recording-state information of the device 30 on the receiving and recording side.

The device 30 on the receiving and recording side may have a responding unit 37 and a command receiving unit 36 for sending the recording-state information by a sending requesting command of the recording-state information of the device 30 on the receiving and recording side from the device 10 on the sending and playing side.

The command receiving unit 36 drives the video reading unit 34 based on the requesting command from the device 10 on the sending and playing side, which will be described later, creates a video signal of the played content recorded to the recording medium 33 on the receiving side in the device 30 on the receiving and recording side or the recording-state information such as a recording operation signal indicating the recording operation of the device 30 on the receiving and recording side, and returns the created information to the device 10 on the sending and playing side from the responding unit 37.

Hereinbelow, a description is given of the move processing of the “Copy Once” content between the device 10 on the sending and playing side and the device 30 on the receiving and recording side with the above-mentioned structure with reference to FIGS. 3 to 5. First, a description is given of the move processing operation of the content in the content recording system according to the first embodiment of the present invention with reference to FIG. 3. FIG. 3 shows an example of the recording-state information using a video signal. According to the first embodiment, the device 10 on the sending and playing side is a recording and playing device, having as a recording medium, an HDD, DVD-RAM or the like for reading and playing the recorded data and erasing the read and played data. The device 30 on the receiving and recording side has a recording medium such as an HDD or DVD-RAM for recording the data and reading and playing the recorded data. According to the first embodiment, the content recording system can perform playing recorded content while recording yet-to-be recorded content, the so-called “time shift”.

The “Copy Once” content distributed from the broadcasting station has video frame identification (ID) Nos., e.g., ID information A, B, C, D, . . . added by the video recording unit 11 and the frame ID information adding unit 12 in the device 10 on the sending and playing side, is converted into the “No More Copies” content, and is recorded to the recording medium 13 on the sending side.

In the video recording unit 11 and the frame ID information adding unit 12, the video frame ID information is added to the “Copy Once” content by using CRC (Cyclic Redundancy Check) indicated in ANSI FDDI Media Access Control (ANSI FDDI media access control) or a random value.

The “No More Copies” content additionally having the ID information A, B, C, D, . . . recorded to the recording medium 13 on the sending side in the device 10 on the sending and playing side is sent and is recorded to the device 30 on the receiving and recording side by the “No More Copies” content recorded to the recording medium 13 on the sending side together with the ID information A, B, C, D, . . . by the video reading unit 14. The video sending unit 15 converts the read content into the “Copy Once” content, and sends it to the device 30 on the receiving and recording side. In this case, the ID information of the content sent to the device 30 on the receiving and recording side is extracted by the frame ID information reading unit 16 to be temporarily stored.

It is assumed that the content having two video frames with ID information A and B is sent. At the timing, the frame ID information reading unit 16 extracts and temporarily stores the ID information A and B of the two sent contents.

The “Copy Once” content of the ID information A and B sent from the device 10 on the sending and playing side is received by the video receiving unit 31 in the device 30 on the receiving and recording side. The video recording unit 32 converts the received contents into the “No More Copies” contents, and re-records them together with the ID information A and B to the recording medium 33 on the receiving side. The contents of the ID information A and B re-recorded to the recording medium 33 on the receiving side are read by the video reading unit 34 and are sent to the device 10 on the sending and playing side by the video sending unit 35. That is, the video signal of the re-recorded contents is returned to the device 10 on the sending and playing side, serving as the recording-state information.

The video signal of the re-recorded contents of the ID information A and B returned from the device 30 on the receiving and recording side is received by the recording-state receiving unit 17 in the device 10 on the sending and playing side. The frame ID information receiving unit 18 extracts the ID information A and B from the video signal of the received re-recorded contents. The recording-state checking unit 19 checks to see if the same ID information as those of the ID information A and B extracted by the frame ID information receiving unit 18 are temporarily recorded to the frame ID information reading unit 16.

In this case, the ID information A and B extracted by the frame ID information receiving unit 18 matches the sent ID information A and B which is temporarily stored in the frame ID information reading unit 16. Therefore, the recording-state checking unit 19 outputs the matching information indicating that both the ID information matches each other. When the ID information of the sent contents from the device 10 on the sending and playing side to the device 30 on the receiving and recording side matches the re-recorded ID information received and recorded by the device 30 on the receiving and recording side, the video erasing unit 20 erases the data to the video frame having the matching ID information, from among the contents recorded to the recording medium 13 on the sending side. That is, at the timing shown in FIG. 3, the video frame having the ID information A and B is erased.

The “Copy Once” content recorded to the device 10 on the sending and playing side is sent and is re-recorded to the device 30 on the receiving and recording side, and the content recorded to the device 10 on the sending and playing side is erased, thus accomplishing the move processing.

When the recording-state checking unit 19 in the device 10 on the sending and playing side determines that the ID information of the sent content does not match the ID information of the re-recorded content from the device 30 on the receiving and recording side, it is determined that the content sent from the device 10 on the sending and playing side is not normally re-recorded by the device 30 on the receiving and recording side. Then, the erasure of the content recorded to the recording medium 13 on the sending side by the video erasing unit 20 stops and the sending and playing operation also stops. As mentioned above, the device 10 on the sending and playing side erases the contents after determining that the sent content is normally recorded by the device 30 on the receiving and recording side.

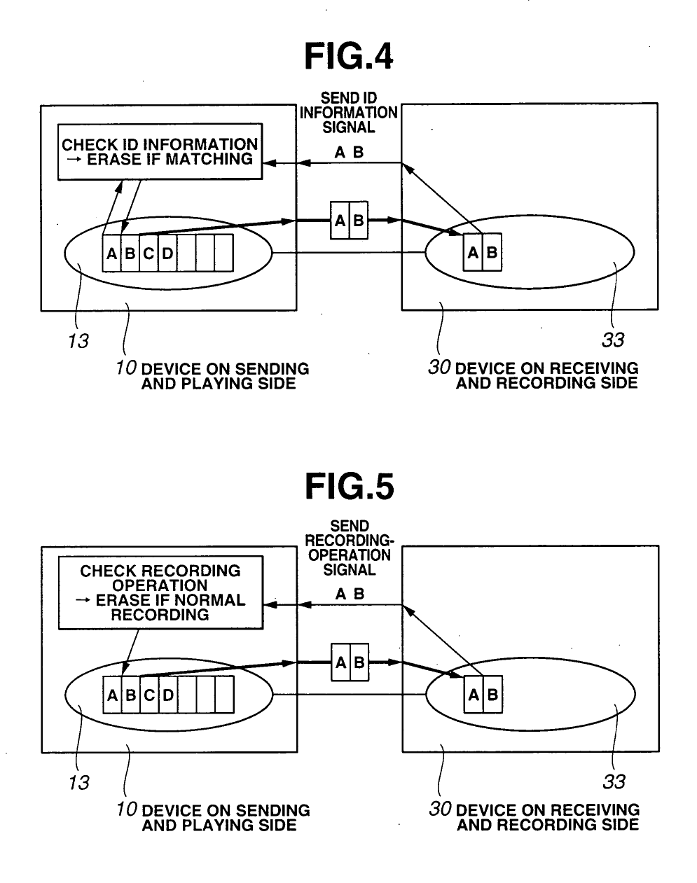

Next, a description is given of the operation of the move processing of the content in a content recording system according to the second embodiment of the present invention with reference to FIG. 4. According to the second embodiment, the recording-state information is an ID information signal.

According to the second embodiment, the device 10 on the sending and playing side is a recording and playing device, having as a recording medium, an HDD, DVD-RAM or the like which reads and plays the recorded data and erases the read and played data. The device 30 on the receiving and recording side has a time-shift recording medium such as an HDD or DVD-RAM for recording the data and reading and playing the recorded data.

Similarly to the first embodiment, the device 10 on the sending and playing side adds video frame ID Nos., e.g., ID information A, B, C, D, . . . to the “Copy Once” content distributed from the broadcasting station, converts them into the “No More Copies” content, and records it to the recording medium 13 on the sending side. In the case of sending and recording the contents additionally having the ID information A, B, C, D, . . . recorded to the recording medium 13 on the sending side to the device 30 on the receiving and recording side, the video reading unit 14 in the device 10 on the sending and playing side reads the “No More Copies” contents including the ID information A, B, C, D, . . . recorded to the recording medium 13 on the sending side, the video sending unit 15 converts the read contents into the “Copy Once” contents and sends them to the device 30 on the receiving and recording side, and the frame ID information reading unit 16 extracts the ID information of the contents, e.g., ID information of the sent contents, to be sent to the device 30 on the receiving and recording side and temporarily stores it.

It is assumed that the video frames of the ID information A and B are sent to the device 30 on the receiving and recording side and the ID information A and B is extracted and is temporarily stored in the frame ID information reading unit 16. The video receiving unit 31 in the device 30 on the receiving and recording side receives the “Copy Once” content additionally having the ID information A and B sent from the device 10 on the sending and playing side, and the video recording unit 32 converts the “Copy Once” content contents into the “No More Copies” content and re-records them to the recording medium 33 on the receiving side together with the ID information A and B.

The device 10 on the sending and playing side returns the contents additionally having the ID information A and B to the device 30 on the receiving and recording side and sends a sending requesting command of the frame ID information. The sending requesting command of the frame ID information from the device 10 on the sending and playing side is received by the command receiving unit 36 in the device 30 on the receiving and recording side. The command receiving unit 36 drives the video reading unit 34 in response to the sending requesting command of the frame ID information, reads the contents re-recorded to the recording medium 33 on the receiving side, extracts the ID information A and B added to the contents, and outputs them to the responding unit 37. The responding unit 37 produces a returning command of the frame ID information, serving as an ID information signal, based on the ID information A and B read and extracted by the video reading unit 34, and returns it to the device 10 on the sending and playing side.

The returning command of the frame ID information returned from the device 30 on the receiving and recording side is received by the recording-state receiving unit 17 in the device 10 on the sending and playing side, and the frame ID information receiving unit 18 extracts the re-recorded ID information A and B in response to the received returning command of the frame ID information. The recording-state checking unit 19 compares the ID information A and B extracted by the recording-state receiving unit 17 and the frame ID information receiving unit 18 with the ID information A and B temporarily stored in the frame ID information reading unit 16 to check the matching. When the recording-state checking unit 19 determines that the ID information A and B of content having been sent from the device 10 on the sending and playing side to the device 30 on the receiving and recording side matches the ID information A and B of content recorded by the device 30 on the receiving and recording side, the video erasing unit 20 erases the contents to the frame having the ID information A and B, from among the contents recorded to the recording medium 13 on the sending side.

Thus, the “Copy Once” content recorded to the device 10 on the sending and playing side is sent to the device 30 on the receiving and recording side and is re-recorded, and the content recorded to the device 10 on the sending and playing side is erased, thereby accomplishing the move processing.

When the recording-state checking unit 19 in the device 10 on the sending and playing side determines that the ID information A and B of the sent content does not match the ID information A and B of the re-recorded content from the device 30 on the receiving and recording side, the device 30 on the receiving and recording side determines that the content sent from the device 10 on the sending and playing side is not normally re-recorded by the device 30 on the receiving and recording side. Then, the erasure of the content recorded to the recording medium 13 on the sending side by the video erasing unit 20 stops and the sending and playing operation also stops. As mentioned above, the device 10 on the sending and playing side erases the contents after determining that the sent content is normally recorded by the device 30 on the receiving and recording side.

Next, a description is given of the operation of the move processing of the content in a content recording system according to the third embodiment of the present invention with reference to FIG. 5. According to the third embodiment, the recording-state information is a recording operation signal.

According to the third embodiment, the device 10 on the sending and playing side is a recording and playing device, having as a recording medium, an HDD, DVD-RAM or the like which reads and plays the recorded data and erases the read and played data. The device 30 on the receiving and recording side is a time-shift recording medium such as an HDD or DVD-RAM for recording the data and reading and playing the recorded data, or a digital video device, having as a recording medium, a magnetic tape for recording digital data of the content sent from the device 10 on the sending and playing side.

Similarly to the first embodiment, the device 10 on the sending and playing side adds video frame ID Nos., e.g., ID information A, B, C, D, . . . to the “Copy Once” content distributed from the broadcasting station, converts them into the “No More Copies” content, and records it to the recording medium 13 on the sending side. In the case of sending and recording the contents additionally having the ID information A, B, C, D, . . . recorded to the recording medium 13 on the sending side to the device 30 on the receiving and recording side, the video reading unit 14 in the device 10 on the sending and playing side reads the “No More Copies” contents including the ID information A, B, C, D, . . . recorded to the recording medium 13 on the sending side, the video sending unit 15 converts the read contents into the “Copy Once” contents and sends them to the device 30 on the receiving and recording side.

It is assumed that the video frames of the ID information A and B are sent to the device 30 on the receiving and recording side and the ID information A and B is extracted and is temporarily stored in the frame ID information reading unit 16. The video receiving unit 31 in the device 30 on the receiving and recording side receives the “Copy Once” content additionally having the ID information A and B sent from the device 10 on the sending and playing side, and the video recording unit 32 converts the “Copy Once” content contents into the “No More Copies” content and re-records them to the recording medium 33 on the receiving side together with the ID information A and B.

The device 10 on the sending and playing side returns the contents additionally having the frame ID information to the device 30 on the receiving and recording side and sends a sending requesting command of the recording operation signal. The sending requesting command of the recording operation signal from the device 10 on the sending and playing side is received by the command receiving unit 36 in the device 30 on the receiving and recording side. The command receiving unit 36 drives the video reading unit 34 in response to the sending requesting command of the recording operation signal, determines whether or not the content is normally re-recorded to the recording medium 33 on the receiving side, and outputs the determining result to the responding unit 37. The responding unit 37 converts the data into a returning command of the recording operation signal and returns it to the device 10 on the sending and playing side in accordance with the determining result of the video reading unit 34.

The returning command of the recording operation signal returned from the device 30 on the receiving and recording side is received by the recording-state receiving unit 17 in the device 10 on the sending and playing side. When the received returning command of the recording operation signal is a command indicating the normal re-recording operation of the device 30 on the receiving and recording side, the video erasing unit 20 erases, from the recording medium 13 on the sending side, the contents to the sent ID information A and B to the device 30 on the receiving and recording side from the device 10 on the sending and playing side.

Thus, the “Copy Once” content recorded to the device 10 on the sending and playing side is sent to the device 30 on the receiving and recording side and is re-recorded, and the content recorded to the device 10 on the sending and playing side is erased, thereby accomplishing the move processing.

When the recording-state checking unit 19 in the device 10 on the sending and playing side determines that the returning command of the recording operation signal from the device 30 on the receiving and recording side indicates that the device 30 on the receiving and recording side does not normally record the content, the erasure of the content recorded to the recording medium 13 on the sending side by the video erasing unit 20 stops and the sending and playing operation also stops.

As mentioned above, the device 10 on the sending and playing side erases the contents after determining that the sent content is normally recorded by the device 30 on the receiving and recording side.

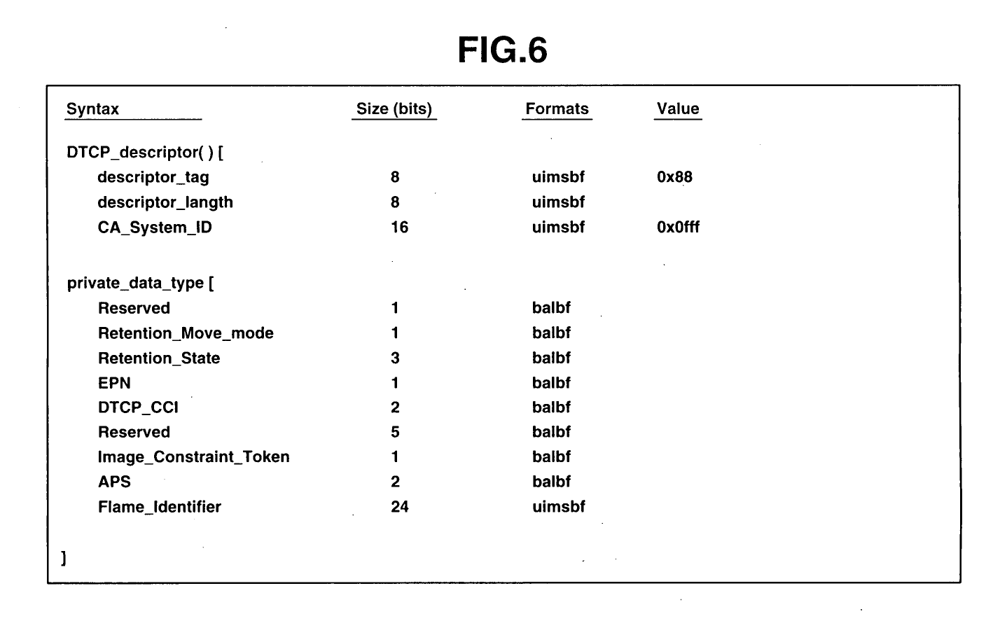

FIG. 6 shows a recording method and a sending method of the ID information added to the video frame of the content in the move processing described with reference to FIGS. 3 to 5. The recording method and the sending method of the ID information are used for the transmission and recording state check using the video signal according to the first embodiment with reference to FIG. 3 and the transmission of the ID information signal according to the second embodiment of the present invention with reference to FIG. 4.

According to the method shown in FIG. 6, the ID information is recorded by a “DTCP_descriptor” format included in MPEG2-TS. The ID information is recorded to an area “private_data_byte” in the “DTCP_descriptor” format. For example, the ID information is recorded to an area “Frame_Identifier” having 24 bits of the area “private_data_byte”. The recording method is “uimsbf” (Unsigned Integer Most Significant Bit First). The ID information is sent via a sending path by the format. Incidentally, the recording method of the ID information includes another method except for the foregoing and the present invention is not limited to the above-mentioned recording method.

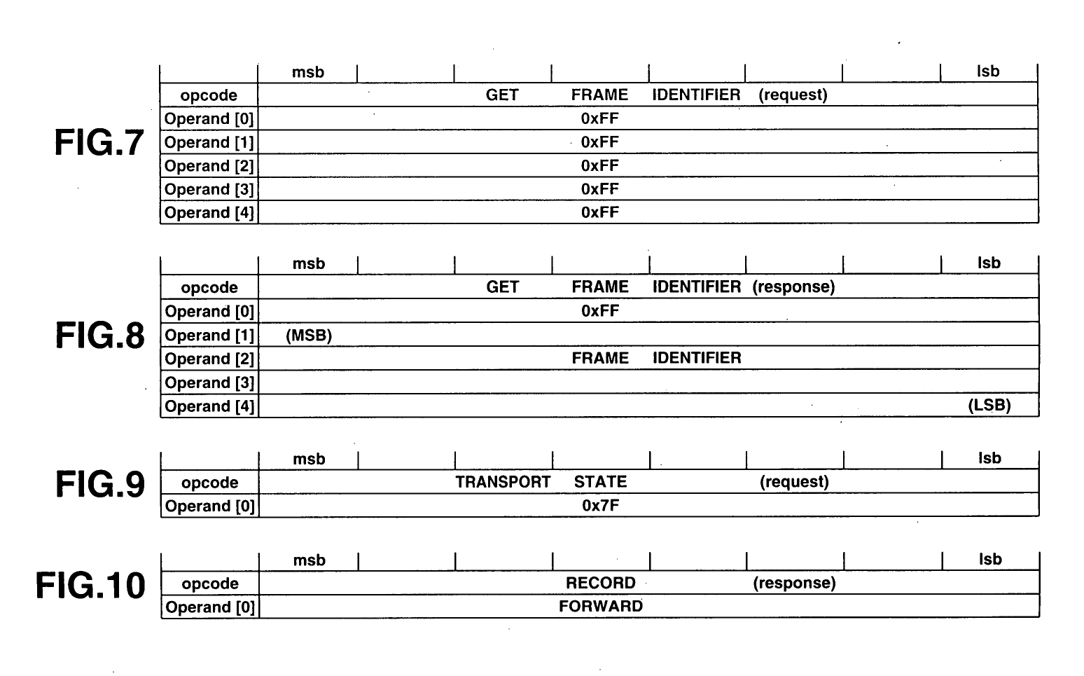

FIGS. 7 and 8 show the recording state checking method according to the second embodiment of the present invention described above with reference to FIG. 4. The device 10 on the sending and playing side sends the ID information requesting command by a format shown in FIG. 7 to the device 30 on the receiving and recording side. The device 30 on the receiving and recording side returns the recording state returning command by a format shown in FIG. 8 to the device 10 on the sending and playing side. A requesting interval of the ID information from the device 10 on the sending and playing side can variously be set. For example, the ID information may be requested and responded at the frame of the video frame, or it may be requested in a lump at the start time of video transmission and then only the response may be received during sending the video image.

FIGS. 9 and 10 show the recording operation checking method according to the third embodiment of the present invention described above with reference to FIG. 5. The device 10 on the sending and playing side sends the recording operation requesting command by a format shown in FIG. 9 to the device 30 on the receiving and recording side. The device 30 on the receiving and recording side returns the recording operation returning command by a format shown in FIG. 10 to the device 10 on the sending and playing side. As will be understood with reference to FIG. 10, the device 30 on the receiving and recording side is in a normal recording state (RECORD FORWARD). Incidentally, the recording operation checking method may include other formats for checking the recording state of the device 30 on the receiving and recording side in addition to the above-described formats, and the present invention is not limited to the above formats.

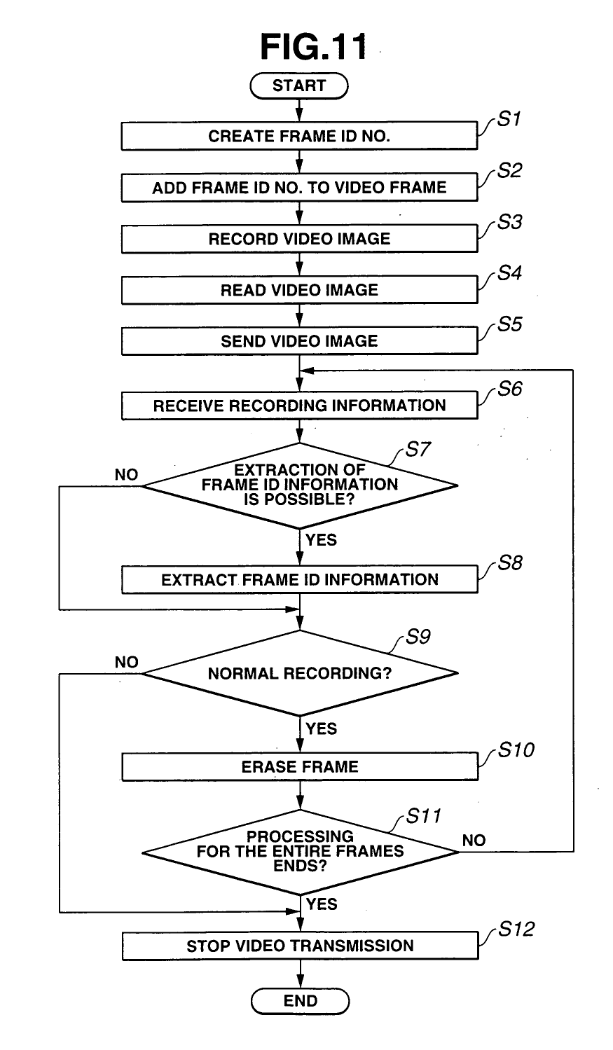

Next, a description is given of the operation for adding the video frame ID information to the content of the device 10 on the sending and playing side and for erasing the content sent to the device 30 on the receiving and recording side with reference to FIG. 11.

In the device 10 on the sending and playing side, the frame ID information adding unit 12 produces the video frame ID No. serving as the video frame ID information (step S1). The video recording unit 11 adds the video frame ID No. produced by the frame ID information adding unit 12 to each video frame of the received contents (step S2). The video recording unit 11 records the content having the video frame ID No. added to each video frame to the recording medium 13 on the sending side (step S3).

In the case of reading the content recorded to the recording medium 13 on the sending side and re-recording it to the recording medium 33 on the receiving side of the device 30 on the receiving and recording side, the video reading unit 14 in the device 10 on the sending and playing side reads the content recorded to the recording medium 13 on the sending side (step S4). The content read by the video reading unit 14 from the recording medium 13 on the sending side is sent to the device 30 on the receiving and recording side from the video sending unit 15, and the video frame ID No. is extracted and is temporarily stored (step S5).

Sequentially, the recording-state receiving unit 17 of the device 10 on the sending and playing side receives the recording information returned from the device 30 on the receiving and recording side (step S6). The receiving and sending method of the recording-state information from the device 30 on the receiving and recording side in the recording-state receiving unit 17 is the method shown in FIG. 6, 8, or 10. The frame ID information receiving unit 18 checks whether or not the video frame ID information is extracted from the recording information received by the recording-state receiving unit 17 (step S7). In the determining processing for extracting the video frame ID information in the frame ID information receiving unit 18, it is determined that the video frame ID No. shown in FIGS. 6 and 8 is extracted. Further, upon returning the ID information returning command, it is determined that the frame ID information is extracted. Upon returning the recording state returning command shown in FIG. 10, it is determined that the frame ID information is not extracted.

The frame ID information receiving unit 18 determines that the video frame ID information is extracted and then the video frame ID information is extracted (step S8). In step S9, it is determined by using the video frame ID information extracted in step S8 or by the recording state returning command that does not include the video frame ID information in step S7, whether or not the device 30 on the receiving and recording side normally records the data (step S9).

In the normal-recording determination of the device 30 on the receiving and recording side in step S9, it is determined by using the recording state returning command whether or not the device 30 on the receiving and recording side normally records the data when it is determined in step S7 that the command is the recording state returning command which does not extract the ID information. When it is determined in step S7 that the ID information is extracted, the frame ID information extracted in step S8 is compared with the sent frame ID information which is extracted and is temporarily stored by the frame ID information reading unit 16 upon sending the video image in step S5. When both the ID information matches each other, it is determined that the device 30 on the receiving and recording side normally re-records the sent content.

When it is determined in step S9 that the device 30 on the receiving and recording side normally records the data, the recording-state checking unit 19 drives the video erasing unit 20 to erase the video frames having the matched frame ID information recorded to the recording medium 13 on the sending side or video frames having been sent and their normal recording having been determined (step S10).

After erasing the video frame in step S10, the video reading unit 14 determines whether or not the erasure of the entire video frames recorded to the recording medium 13 on the sending side ends (step S11). As a result of the determination in step S11, it is determined that the recording medium 13 on the sending side has the video frame that is not erased and then the processing returns to step S6 whereupon the reception of next recording information is determined. As a result of the determination in step S11, it is determined that the erasure of the entire video frames of the recording medium 13 on the sending side ends, the transmission of the content from the device 10 on the sending and playing side stops (stop S12).

When it is determined in step S9 by using the recording information from the device 30 on the receiving and recording side that the device 30 on the receiving and recording side does not normally records the data, the transmission of the content of the device 10 on the sending and playing side stops (step S12).

As mentioned above, after determining the recording state of the device on the receiving and recording side by the recording state checking unit arranged on the device on the sending and playing side, the content on the device on the sending and playing side is erased. It is possible to prevent the erasure of the content, when any trouble of the recording operation of the device on the receiving and recording side is caused and the move processing is unsuccessful. Further, it is possible to certainly erase the content recorded to the device on the sending and playing side after the device on the receiving and recording side normally receives and records the content.

Having described the preferred embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

1. A content recording method comprising:
step to record a received content to a first recording medium;
step to play the content recorded to the first recording medium;
step to record the content played from the first recording medium to a second recording medium;
step to produce recording-state information indicating a recording state to the second recording medium; and
step to erase the content recorded to the first recording medium based on the recording-state information.

2. A content recording method using a recording and playing device on the sending side for recording a received content to a recording medium on the sending side and sending the played content and a recording and playing device on the receiving side for receiving the played content sent from the device on the sending and playing side and recording the played content to a recording medium on the receiving side, the content recording method comprising:
step to produce recording-state information indicating a recording state of the played content sent from the recording and playing device on the sending side to the second recording medium and returning the produced information to the recording and playing device on the sending side, by the recording and playing device on the receiving side; and
step to erase the sent content recorded to the recording medium on the sending side based on the recording-state information of the played content returned from the recording and playing device on the receiving side, by the recording and playing device on the sending side.

3. A content recording method according to claim 2, comprising:
step to add predetermined frame ID information serving as an ID information signal and recording it upon recording the received content to the recording medium and outputting the played content including the ID information signal to the recording and playing device on the receiving side, by the recording and playing device on the sending side.

4. A content recording method according to claim 2, wherein the recording-state information of the played content which is produced and is returned by the recording and playing device on the receiving side to the recording medium has any of a video signal of the played content sent from the recording and playing device on the sending side, an ID information signal added to the played content, and a recording operation signal of the played content of the recording and playing device on the receiving side.

5. A content recording method according to claim 4, further comprising: step to check to see if a video signal of the played content returned from the recording and playing device on the receiving side matches a video signal of the sent played content to erase the played content having been sent and normally recorded to the recording medium, by the recording and playing device on the sending side, in a case that the recording-state information of the played content returned from the recording and playing device on the receiving side is a video signal of the played content.

6. A content recording method according to claim 4, further comprising: step to extract an ID information signal included in the video signal of the played content returned from the recording and playing device on the receiving side, checking to see if the extracted ID information signal matches the ID information signal of the sent played content to erase the played content having been sent and normally recorded to the recording medium, by the recording and playing device on the sending side, in a case that the played content of the recording-state information of the played content returned from the recording and playing device on the receiving side is a video signal of the played content.

7. A content recording method according to claim 4, further comprising: step to check to see if the ID information signal of the played content returned from the recording and playing device on the receiving side matches the ID information signal of the video signal of the sent played content to erase the played content having been sent and normally recorded to the recording medium, by the recording and playing device on the sending side, in a case that the recording-state information of the played content returned. from the recording and playing device on the receiving side is an ID information signal of the played content.

8. A content recording method according to claim 4, further comprising: step to erase the sent played content which is recorded to the recording medium when the normal recording of the played content in the recording and playing device on the receiving side is determined by the recording operation signal of the played content returned from the recording and playing device on the receiving side, by the recording and playing device on the sending side, in a case that the recording-state information of the played content returned from the recording and playing device on the receiving side is a recording operation signal of the played content of the recording and playing device on the receiving side.

9. A content recording method according to claim 2, further comprising: step to temporarily store the ID information signal added to the content and comparing the stored signal with the ID information signal included in the recording-state information from the recording and playing device on the receiving side, by the recording and playing device on the sending side, upon playing and sending the content recorded to the recording medium.

10. A content recording system comprising:
a first recording unit which records a received content to a first recording medium;
a first playing unit which plays the content recorded to the first recording medium;
a second recording unit which records the content played from the first recording medium to a second recording medium;
a recording-state information producing unit which produces recording-state information indicating a recording state to the second recording medium; and
an erasing unit which erases the content recorded to the first recording medium based on the recording-state information.

11. A content recording system according to claim 10, wherein the content permits one-time recording based on copyright protecting information.

12. A content recording system comprising a recording and playing device on the sending side which records a received content to a recording medium on the sending side and sends the played content and a recording and playing device on the receiving side which receives the played content sent from the recording and playing device on the sending side and recording the played content to a recording medium on the receiving side,
wherein the recording and playing device on the sending side comprises:
a first video recording unit which adds ID information to the received content and records the ID information to the recording medium on the sending side;
a first video reading unit which reads the content additionally having the ID information recorded to the recording medium on the sending side and sends the played content to the recording and playing device on the receiving side;
an ID information reading unit which extracts the ID information added to the played content that is read by the first video reading unit and is sent to the recording and playing device on the receiving side and temporarily stores the extracted ID information; and
a video erasing unit which receives recording-state information of the played content to the recording medium on the receiving side by the recording and playing device on the receiving side, checks to see if the received recording-state information matches the ID information temporarily stored by the ID information reading unit, and erases the determined matching ID information from the content recorded to the recording medium on the sending side, and
the recording and playing device on the receiving side comprises:
a second video recording unit which records the played content including the ID information sent from the recording and playing device on the sending side to the recording medium on the receiving side;
a second video reading unit which reads the played content recorded to the recording medium on the receiving side by the second video recording unit and produces the recording-state information of the read played content; and
a video sending unit which sends the recording-state information of the played content produced by the second video reading unit to the recording and playing device on the second side.

13. A recording and playing device comprising:
a video recording unit which adds ID information to a received content and records the added ID information to a recording medium on the sending side;
a video reading unit which reads and plays the content recorded to the recording medium on the sending side and sends the played content that is read and is played to a recording and playing device on the receiving side;
a recording state checking unit which checks to see if the recording and playing device on the receiving side normally records the played content, based on the recording-state information of the played content returned from the recording and playing device on the receiving side to the recording medium on the receiving side; and
a video erasing unit which erases, from the content recorded to the recording medium on the sending side, the information determined that the recording and playing device on the receiving side normally records the played content sent from the video reading unit in the recording state checking unit.

14. A recording and playing device according to claim 13, wherein the ID information added to the content in the video recording unit is frame ID information arranged to a predetermined frame unit of the content.

15. A recording and playing device according to claim 13, wherein the recording state checking unit checks a recording operation state of the played content in the recording and playing device on the receiving side by using any of the ID information added to the played content included in the recording-state information returned from the recording and playing device on the receiving side and a recording operation signal of the recording and playing device on the receiving side.
